(19) United States
(12) Patent Application Publication
(10) Pub. No.: US 2026/0031464 A1
(43) Pub. Date: Jan. 29, 2026

(54) BATTERY MODULE

(71) Applicant: YAZAKI CORPORATION, Tokyo (JP)

(72) Inventors: Mariko Nakagawa, Makinohara-shi (JP); Katsunori Sato, Makinohara-shi (JP); Tatsuya Oga, Makinohara-shi (JP); Seigo Mochizuki, Fujieda-shi (JP)

(21) Appl. No.: 19/180,217

(22) Filed: Apr. 16, 2025

(30) Foreign Application Priority Data
May 16, 2024 (JP) 2024-080282

(51) Int. Cl. H01M 50/262; H01M 50/209; H01M 50/284; H01M 50/298

(52) U.S. Cl. CPC H01M 50/262; H01M 50/209; H01M 50/284; H01M 50/298

(57) ABSTRACT

A battery module includes a case that accommodates a wiring member; and a plate member that is disposed at an end portion of each of a plurality of battery cells and supports the case, in which a lock hole and a guide hole are provided side by side on a side surface of the plate member facing the case, the case includes a main body that accommodates the wiring member, and an engagement protrusion and a guide protrusion protruding from the main body, the engagement protrusion is inserted into the lock hole to engage with the plate member, and the guide protrusion is inserted into the guide hole to guide the engagement protrusion to the lock hole, and is longer than the engagement protrusion.

### CROSS-REFERENCE TO RELATED APPLICATION(S)

The present application claims priority to and incorporates by reference the entire contents of Japanese Patent Application No. 2024-080282 filed in Japan on May 16, 2024.

### BACKGROUND OF THE INVENTION

### 1. Field of the Invention

The present invention relates to a battery module.

### 2. Description of the Related Art

In the related art, there is a module having a plurality of batteries. JP 2014-093 218 A discloses a power supply device including a battery assembly and a pair of bus bar modules attached to both side surfaces of the battery assembly. The bus bar module includes a plurality of bus bars that connect a plurality of batteries in series, voltage detection terminals connected to the respective bus bars, a pair of power supply terminals, and a case that accommodates these.

When a case is fixed to a plate member disposed at end portions of a plurality of battery cells, it is desirable that the work of assembling the case to the plate member can be made efficient.

### SUMMARY OF THE INVENTION

An object of the present invention is to provide a battery module capable of improving efficiency of work of assembling a case to a plate member.

In order to achieve the above mentioned object, a battery module according to one aspect of the present invention includes a case that accommodates a wiring member connected to a plurality of battery cells arranged side by side; and a plate member that is disposed at an end portion of each of the plurality of battery cells and supports the case, wherein a lock hole and a guide hole are provided side by side on a side surface of the plate member facing the case, the case includes a main body that accommodates the wiring member, and an engagement protrusion and a guide protrusion protruding from the main body, the engagement protrusion is inserted into the lock hole to engage with the plate member, and the guide protrusion is inserted into the guide hole to guide the engagement protrusion to the lock hole, and is longer than the engagement protrusion.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a view illustrating a battery module and a battery pack according to an embodiment;

FIG. 2 is a perspective view of the battery module according to the embodiment;

FIG. 3 is a perspective view of a case according to the embodiment;

FIG. 4 is a side view of the case according to the embodiment;

FIG. 5 is a sectional view of the case according to the embodiment;

FIG. 6 is a perspective view of the battery module according to the embodiment;

FIG. 7 is a side view of the battery module according to the embodiment; and

FIG. 8 is a view illustrating an example of a guide protrusion according to the embodiment.

### DETAILED DESCRIPTION OF THE PREFERRED EMBODIMENTS

Hereinafter, a battery module according to an embodiment of the present invention will be described in detail with reference to the drawings. Note that the present invention is not limited by the present embodiment.

In addition, constituent elements in the following embodiments include those that can be easily assumed by those skilled in the art or those that are substantially the same.

### EMBODIMENT

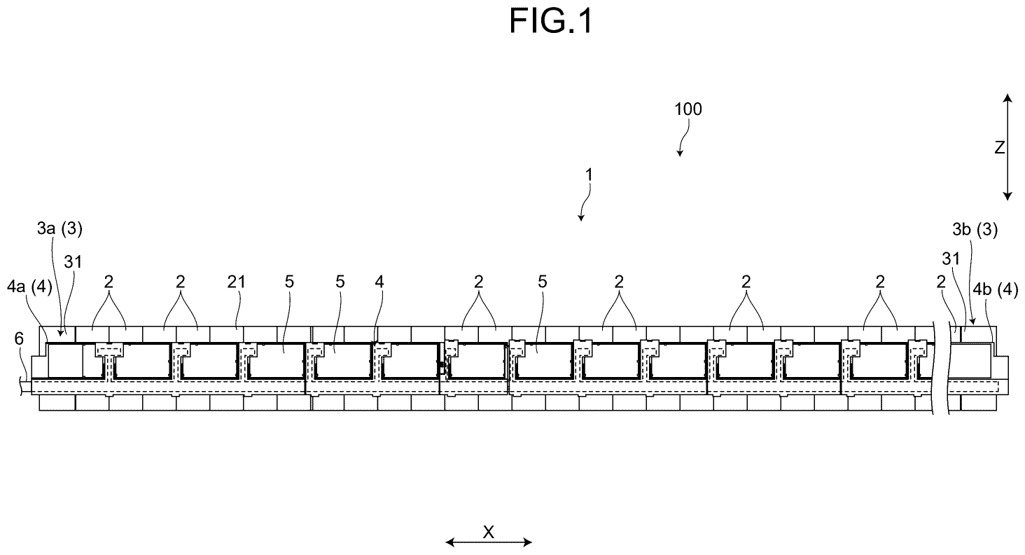

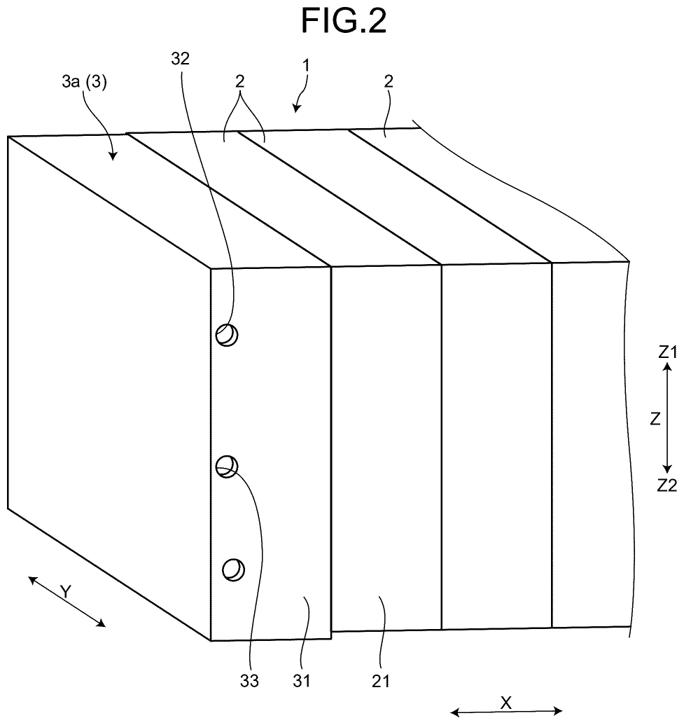

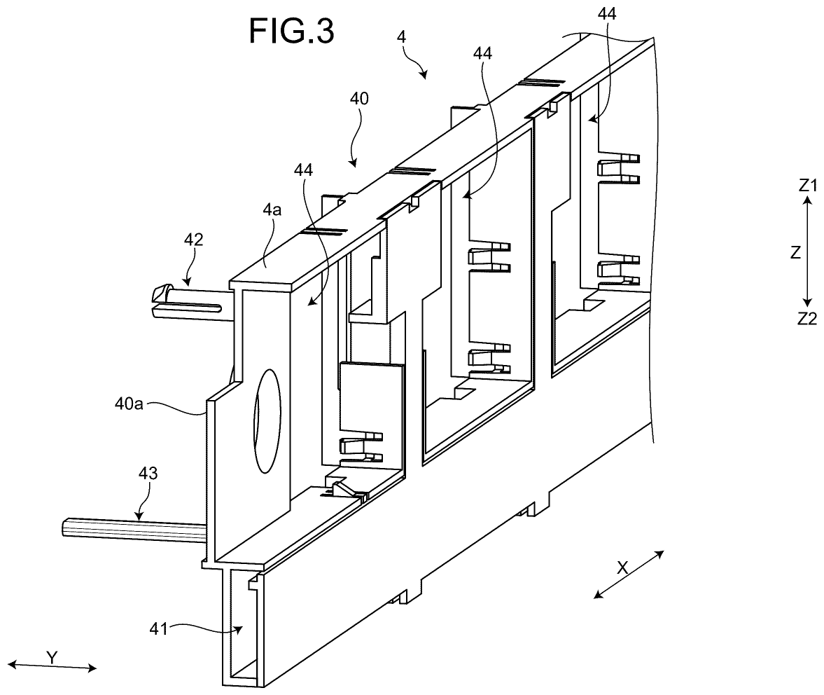

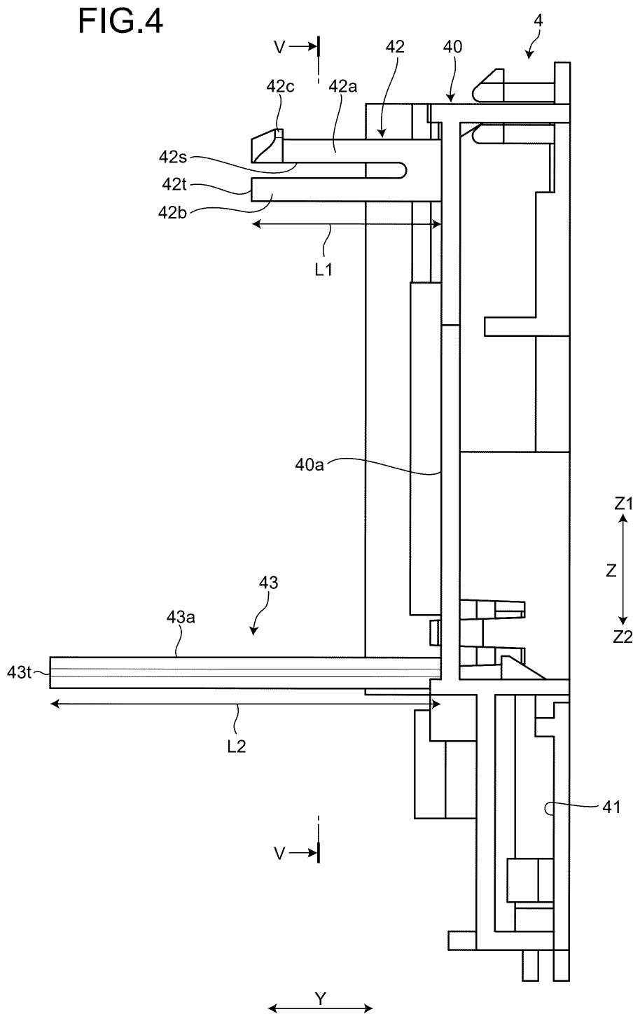

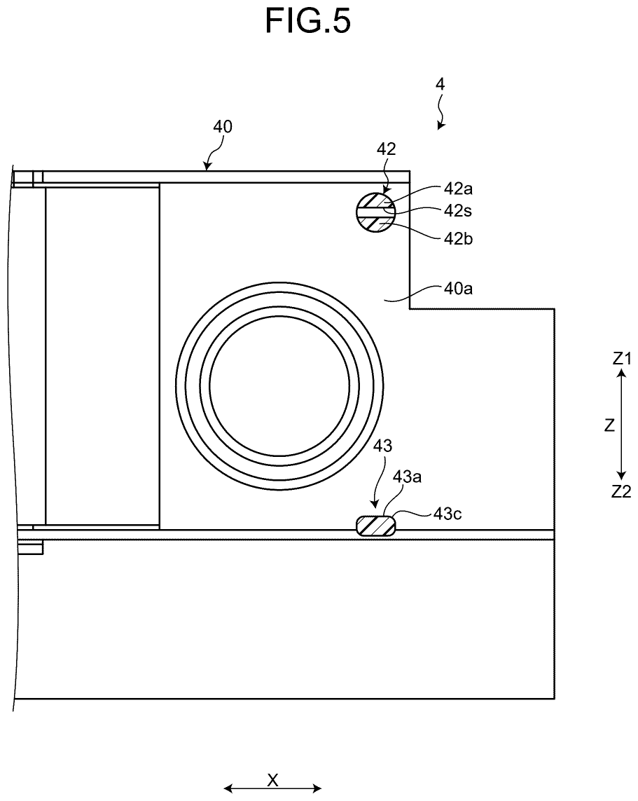

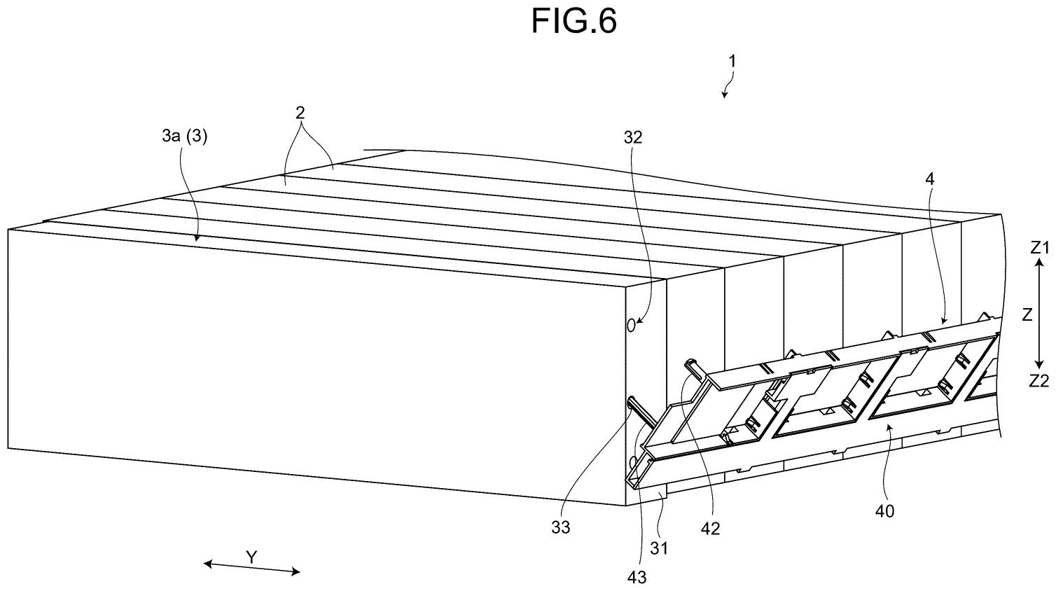

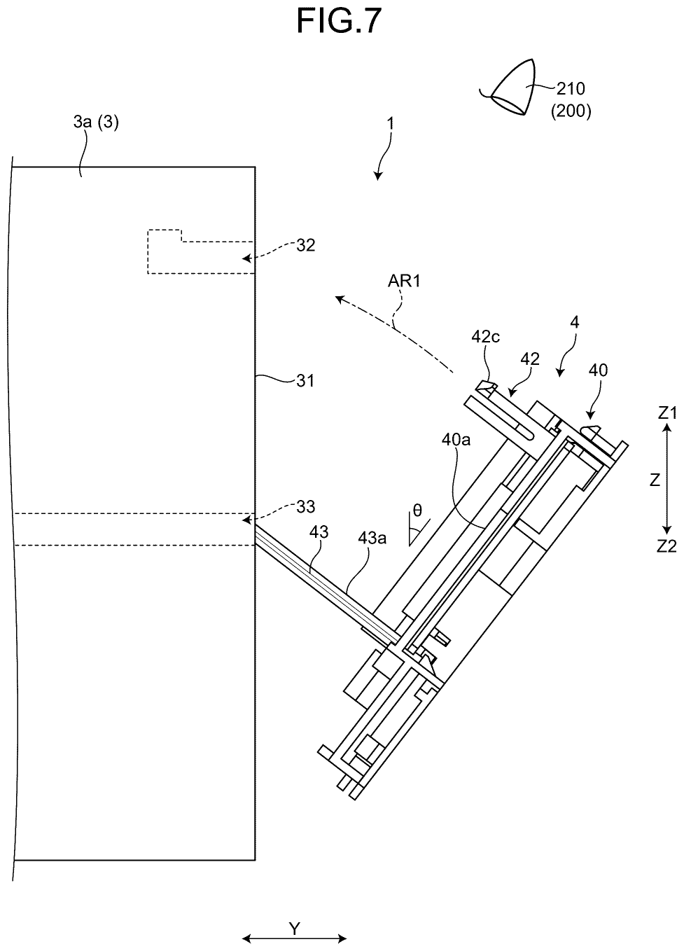

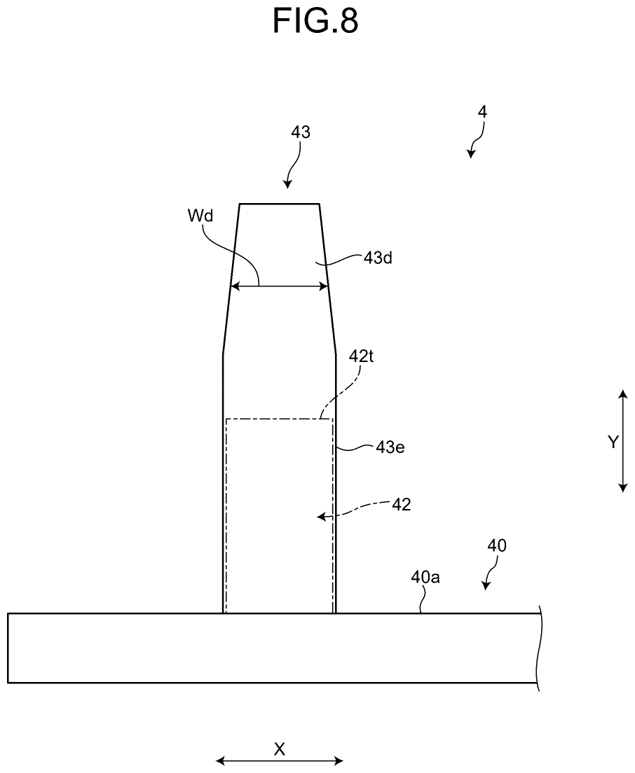

An embodiment will be described with reference to FIGS. 1 to 8. The present embodiment relates to a battery module. FIG. 1 is a view illustrating a battery module and a battery pack according to an embodiment, FIG. 2 is a perspective view of the battery module according to the embodiment, FIG. 3 is a perspective view of a case according to the embodiment, FIG. 4 is a side view of the case according to the embodiment, FIG. 5 is a sectional view of the case according to the embodiment, FIG. 6 is a perspective view of the battery module according to the embodiment, FIG. 7 is a side view of the battery module according to the embodiment, and FIG. 8 is a view illustrating an example of a guide protrusion according to the embodiment. FIG. 5 illustrates a V-V cross section of FIG. 4.

As illustrated in FIG. 1, a battery module 1 of the present embodiment includes a plurality of battery cells 2, a plate member 3, a case 4, a plurality of bus bars 5, and a wiring member 6. The battery module 1 of the present embodiment is a component of a battery pack 100. The battery pack 100 may include a plurality of battery modules 1. The battery pack 100 is mounted as a power source on a vehicle such as an electric vehicle or a hybrid electric vehicle, for example.

The plurality of battery cells 2 are arranged along a first direction X. The battery cell 2 includes a side surface 21 along a vertical direction Z. FIG. 1 illustrates one side surface 21 of a pair of side surfaces 21 of the battery cell 2. The battery cell 2 includes an electrode disposed on the side surface 21. In one battery cell 2, a positive electrode is disposed on one side surface 21 of two side surfaces 21, and a negative electrode is disposed on the other side surface 21.

The plate member 3 is a plate-shaped member disposed at end portions of the plurality of battery cells 2. The plate member 3 of the present embodiment is a member called an end plate, and is formed of, for example, a synthetic resin. The plate member 3 is disposed at both ends of the plurality of battery cells 2 so as to sandwich and hold the plurality of battery cells 2 disposed side by side. The battery module 1 of the present embodiment has at least two plate members 3a and 3b. One plate member 3a is disposed at one end in the first direction X, and the other plate member 3b is disposed at the other end in the first direction X. The plate member 3 includes a side surface 31 along the vertical direction Z. The side surface 31 is aligned with the side surface 21 of the battery cell 2 in the first direction X. FIG. 1 illustrates one side surface 31 of the pair of side surfaces 31 of the plate member 3. The bus bar 5 is a conductor formed of a conductive metal plate, and is fixed to the electrode of the battery cell 2. The bus bar 5 connects, for example, two adjacent battery cells 2 in series. In this case, the bus bar 5 connects the positive electrode of one battery cell 2 and the negative electrode of the other battery cell 2.

The wiring member 6 is connected to the plurality of bus bars 5. The wiring member 6 is, for example, a flat wiring member such as a flexible printed board. When the wiring member 6 is a flexible printed board, the wiring member 6 includes a base film, a coverlay, and a conductive layer. The base film and the coverlay are flexible insulating resin layers. The conductive layer is sandwiched and protected by the base film and the coverlay. The conductive layer is, for example, a conductive metal foil, and has a plurality of circuit patterns connected to the bus bar 5. The wiring member 6 is connected to, for example, a monitoring device that monitors the battery module 1. The monitoring device is a device that monitors the voltage and temperature of the battery cell 2.

The case 4 accommodates the wiring member 6 and the bus bar 5. The case 4 is molded using, for example, an insulating synthetic resin. The case 4 of the present embodiment is assembled to the plate member 3 and supported by the plate member 3. One end portion 4a of the case 4 is supported by one plate member 3a. The other end portion 4b of the case 4 is supported by another plate member 3b. When the other plate member 3 is disposed between the two plate members 3a and 3b, an intermediate portion of the case 4 may be assembled to the other plate member 3 and supported by the other plate member 3.

As illustrated in FIG. 2, the plate member 3 includes a lock hole 32 and a guide hole 33. An engagement protrusion 42 of the case 4 is inserted into the lock hole 32. A guide protrusion 43 of the case 4 is inserted into the guide hole 33. The lock hole 32 and the guide hole 33 are open to the side surface 31 of the plate member 3 and extend in the second direction Y. The second direction Y is a width direction of the plate member 3, and is orthogonal to both the first direction X and the vertical direction Z. The sectional shapes of the lock hole 32 and the guide hole 33 on the surface orthogonal to the second direction Y are, for example, circular.

The lock hole 32 and the guide hole 33 are arranged along the vertical direction Z. The lock hole 32 is located on the upper side Z1 with respect to the guide hole 33. The lock hole 32 and the guide hole 33 are provided in each of the pair of side surfaces 31 of the plate member 3. That is, the plate member 3 is configured such that the case 4 can be assembled to each of the two side surfaces 31.

As illustrated in FIG. 3, the case 4 includes a main body 40, an engagement protrusion 42, and a guide protrusion 43. The main body 40, the engagement protrusion 42, and the guide protrusion 43 of the present embodiment are integrally molded. The main body 40 includes a wiring path 41 for accommodating the wiring member 6 and a plurality of holding portions 44 for accommodating the bus bar 5. The wiring path 41 has a groove shape and extends along the first direction X. The plurality of holding portions 44 are adjacent to the wiring path 41 in the vertical direction Z and are arranged along the first direction X. The case 4 is assembled to the plate member 3 such that the wiring path 41 is located on the lower side Z2 with respect to the holding portion 44.

The main body 40 has a facing surface 40a. The facing surface 40a is a surface facing the battery cell 2 and the plate member 3. That is, the facing surface 40a is a surface facing the side opposite to the side of the wiring member 6 accommodated in the wiring path 41.

The engagement protrusion 42 and the guide protrusion 43 are disposed at two end portions 4a and 4b of the case 4, respectively. The engagement protrusion 42 and the guide protrusion 43 protrude from the facing surface 40a in the second direction Y. The engagement protrusion 42 and the guide protrusion 43 are arranged in the vertical direction Z. The engagement protrusion 42 is disposed on the upper side Z1 in the vertical direction Z with respect to the guide protrusion 43.

The engagement protrusion 42 has a columnar shape. As illustrated in FIG. 4, the engagement protrusion 42 is provided with a slit 42s that divides the engagement protrusion 42 into a first arm 42a and a second arm 42b. The slit 42s extends from the tip end of the engagement protrusion 42 along the axial direction of the engagement protrusion 42. The sectional shape of the first arm 42a and the second arm 42b is a substantially semicircular shape. A claw 42c locked by the plate member 3 is provided at the tip end of the first arm 42a. The claw 42c protrudes outward and has a locking surface facing the main body 40. The engagement protrusion 42 including the slit 42s can be inserted into the lock hole 32 while flexurally deforming the first arm 42a.

The guide protrusion 43 has a plate shape. As illustrated in FIG. 5, the sectional shape of the guide protrusion 43 on the surface orthogonal to the axial direction of the guide protrusion 43 is a flat shape in which the first direction X is the longitudinal direction. The sectional shape of the guide protrusion 43 illustrated in FIG. 5 is substantially rectangular. More specifically, an arc-shaped chamfered portion 43c is formed at a corner portion of the guide protrusion 43. The guide protrusion 43 includes a plane 43a facing the engagement protrusion 42. The plane 43a is a plane facing the upper side Z1 in the vertical direction Z, and is, for example, orthogonal to the vertical direction Z.

As illustrated in FIG. 4, in the case 4 of the present embodiment, the guide protrusion 43 is longer than the engagement protrusion 42. That is, a length L2 of the guide protrusion 43 is larger than a length L1 of the engagement protrusion 42. The length L1 is a length from the facing surface 40a to a tip end 42t of the engagement protrusion 42. The length L2 is a length from the facing surface 40a to a tip end 43t of the guide protrusion 43.

The tip end 43t of the guide protrusion 43 is located farther from the main body 40 than the tip end 42t of the engagement protrusion 42. In other words, when viewed from the vertical direction Z, the tip end 43t of the guide protrusion 43 protrudes with respect to the tip end 42t of the engagement protrusion 42. This improves workability of work of assembling the case 4 to the plate member 3 as described below.

FIGS. 6 and 7 illustrate the case 4 when the assembly to the plate member 3 is started. The work of assembling the case 4 to the plate member 3 is performed by, for example, an operator 200. The plate member 3 is installed such that the side surface 31 is along the vertical direction Z. The operator 200 holds the case 4 so as to direct the guide protrusion 43 and the engagement protrusion 42 toward the plate member 3. In FIGS. 6 and 7, in the case 4, the engagement protrusion 42 is located on the upper side Z1 with respect to the guide protrusion 43.

The operator 200 inclines the facing surface 40a of the case 4 with respect to the vertical direction Z. The inclination direction of the facing surface 40a with respect to the vertical direction Z is a direction away from the side surface 31 as it goes from the guide protrusion 43 toward the engagement protrusion 42. That is, the case 4 is held such that the facing surface 40a faces obliquely upward.

The operator 200 inserts the guide protrusion 43 into the guide hole 33 of the plate member 3. Of the two guide protrusions 43 of the case 4, one guide protrusion 43 is inserted into the guide hole 33 of the plate member 3a, and the other guide protrusion 43 is inserted into the guide hole 33 of the plate member 3b. Thus, the case 4 extends from the plate member 3a at one end to the plate member 3b at the other end in the direction in which the battery cells 2 are arranged. FIGS. 6 and 7 illustrate a state in which the tip end of the guide protrusion 43 is inserted into the guide hole 33. In the case 4 of the present embodiment, the guide protrusion 43 is longer than the engagement protrusion 42. Therefore, the line of sight when the guide protrusion 43 is viewed from eyes 210 of the operator 200 is hardly blocked by the engagement protrusion 42.

As illustrated in FIG. 7, the operator 200 can easily insert the guide protrusion 43 into the guide hole 33 while visually observing the tip end portion of the guide protrusion 43 with the eyes 210. Since the guide protrusion 43 includes the plane 43a, the guide protrusion 43 is smoothly inserted into the guide hole 33. The plane 43a of the guide protrusion 43 faces the eyes 210 of the operator 200. Therefore, when viewed from the operator 200, the tip end of the guide protrusion 43 is easily aligned with an opening of the guide hole 33, and the insertion work is facilitated.

The operator 200 can insert the other guide protrusion 43 into the other guide hole 33 while inserting the one guide protrusion 43 into the one guide hole 33. Since the guide protrusion 43 has a sufficient length, the tip end portion of the one guide protrusion 43 can be supported by the guide hole 33. Therefore, in the long battery module 1 having multi-stage battery cells 2, two guide protrusions 43 can be easily inserted into the guide holes 33.

When the two guide protrusions 43 are inserted into the guide hole 33, the operator 200 inserts the guide protrusion 43 into the depth side of the guide hole 33. As a result, the engagement protrusion 42 is guided to the lock hole 32 as indicated by an arrow AR1 in FIG. 7. In the battery module 1 of the present embodiment, the posture of case 4 is controlled by inserting the guide protrusions 43 into the guide holes 33. More specifically, the guide protrusion 43 changes the posture of the case 4 such that the inclination angle θ of the facing surface 40a decreases as the insertion amount into the guide hole 33 increases. Therefore, the positioning of the engagement protrusion 42 with respect to the lock hole 32 is automatically performed, and the workability of the assembling work is improved. When the engagement protrusion 42 is inserted into the lock hole 32, the claw 42c of the engagement protrusion 42 is locked by the lock hole 32. Thus, the case 4 is fixed to the plate member 3. The case 4 is disposed such that the facing surface 40a faces the side surface 31 of the plate member 3 and the side surface 21 of the battery cell 2.

The guide protrusion 43 may have a tapered shape. For example, as illustrated in FIG. 8, the guide protrusion 43 may include a tapered portion 43d and a portion 43e on the proximal end side. The tapered portion 43d is provided at a tip end portion of the guide protrusion 43. The tapered portion 43d has a tapered shape in which the sectional area decreases toward the tip end of the guide protrusion 43. The tapered portion 43d illustrated in FIG. 8 is configured such that a width Wd in the first direction X becomes narrower toward the tip end of the tapered portion 43d. The tapered portion 43d may be configured such that the thickness decreases toward the tip end of the tapered portion 43d.

The guide protrusion 43 including the tapered portion 43d facilitates the work of inserting the guide protrusion 43 into the guide hole 33. When the entire tapered portion 43d is accommodated in the guide hole 33, the portion 43e on the proximal end side than the tapered portion 43d enters the guide hole 33. By inserting the portion 43e on the proximal end side into the guide hole 33, a gap between the guide protrusion 43 and the guide hole 33 is reduced, and the posture of the case 4 is stabilized.

For example, the tapered portion 43d may be disposed on the tip end side than the engagement protrusion 42. That is, the tapered portion 43d may be provided in a portion farther from the main body 40 than the tip end 42t of the engagement protrusion 42. With such a configuration, it is easy to insert the guide protrusion 43 into the guide hole 33, and a guide function of guiding the engagement protrusion 42 to the lock hole 32 is secured.

The range of the tapered portion 43d when the tapered portion 43d is provided in the guide protrusion 43 is not limited to the range illustrated in FIG. 8. For example, the tapered portion 43d may be disposed such that a part of the tapered portion 43d overlaps the engagement protrusion 42 when viewed in the vertical direction Z. For example, the entire guide protrusion 43 may be the tapered portion 43d.

As described above, the battery module 1 of the present embodiment includes the case 4 accommodating the wiring member 6 and the plate member 3. The wiring member 6 is connected to the plurality of battery cells 2 arranged side by side. The plate member 3 is disposed at an end portion of each of the plurality of battery cells 2 and supports the case 4. On the side surface 31 of the plate member 3 facing the case 4, the lock hole 32 and the guide hole 33 are provided side by side.

The case 4 includes the main body 40 that accommodates the wiring member 6, and the engagement protrusion 42 and the guide protrusion 43 protruding from the main body 40. The engagement protrusion 42 is inserted into the lock hole 32 to engage with the plate member 3. The guide protrusion 43 is inserted into the guide hole 33 to guide the engagement protrusion 42 to the lock hole 32. The guide protrusion 43 is longer than the engagement protrusion 42. According to the battery module 1 of the present embodiment, the guide protrusion 43 can be easily inserted into the guide hole 33, and the workability of the work of assembling the case 4 to the plate member 3 can be improved.

The shape of the tip end portion of the guide protrusion 43 may be a tapered shape that becomes narrower with increasing distance from the main body 40. In this case, the guide protrusion 43 can be more easily inserted into the guide hole 33.

The lock hole 32 and the guide hole 33 of the present embodiment are provided on the side surface 31 extending in the vertical direction Z of the plate member 3 and are arranged in the vertical direction Z. The lock hole 32 is located on the upper side Z1 with respect to the guide hole 33. The case 4 is disposed so as to face the side surface 21 of the battery cell 2 in the vertical direction Z. With such a configuration, when the case 4 is assembled to the plate member 3, the operator 200 can easily view the tip end portion of the guide protrusion 43 from above.

The shape of the guide protrusion 43 of the present embodiment is a shape having the plane 43a facing the engagement protrusion 42. Therefore, it is easy for the operator 200 to insert the guide protrusion 43 into the guide hole 33 while viewing the guide protrusion 43 from above.

The shape of the engagement protrusion 42 and the shape of the guide protrusion 43 are not limited to the shapes exemplified in the embodiment. For example, the shape of the guide protrusion 43 may be a semicircular shape having a chord corresponding to the plane 43a. The shapes of the lock hole 32 and the guide hole 33 are not limited to the shapes exemplified in the embodiment.

The contents disclosed in the above embodiments can be appropriately combined and executed.

In the battery module according to the present embodiment, a lock hole and a guide hole are provided side by side on a side surface of the plate member facing a case, and the case includes a main body that accommodates a wiring member, and an engagement protrusion and a guide protrusion protruding from the main body. The engagement protrusion is inserted into the lock hole to engage with the plate member, and the guide protrusion is inserted into the guide hole to guide the engagement protrusion into the lock hole and is longer than the engagement protrusion. According to the battery module of the present embodiment, it is possible to easily insert the guide protrusion into the guide hole and to efficiently assemble the case to the plate member.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A battery module comprising:
a case that accommodates a wiring member connected to a plurality of battery cells arranged side by side; and
a plate member that is disposed at an end portion of each of the plurality of battery cells) and supports the case,
wherein a lock hole and a guide hole are provided side by side on a side surface of the plate member facing the case,
the case includes a main body that accommodates the wiring member, and an engagement protrusion and a guide protrusion protruding from the main body,
the engagement protrusion is inserted into the lock hole to engage with the plate member, and
the guide protrusion is inserted into the guide hole to guide the engagement protrusion to the lock hole, and is longer than the engagement protrusion.

2. The battery module according to claim 1, wherein
a shape of a tip end portion of the guide protrusion is a tapered shape that becomes narrower with increasing distance from the main body.

3. The battery module according to claim 1, wherein
the lock hole and the guide hole are provided on the side surface of the plate member extending in a vertical direction and are arranged in the vertical direction, and
the lock hole is located on an upper side with respect to the guide hole, and
the case is disposed to face a side surface of the battery cell in the vertical direction.

4. The battery module according to claim 3, wherein
a shape of the guide protrusion is a shape having a plane facing the engagement protrusion.
